(19) United States
(12) Patent Application Publication
(10) Pub. No.: US 2015/0336372 A1
(43) Pub. Date: Nov. 26, 2015

(54) Screen Printing Device and Method

(71) Applicant: Claude Louis Van Ness, Waco, TX (US)

(72) Inventor: Claude Louis Van Ness, Waco, TX (US)

(21) Appl. No.: 14/120,486

(22) Filed: May 23, 2014

(51) Int. Cl. B41C 1/14; B05D 3/06

(52) U.S. Cl. CPC B41C 1/14; B05D 3/067

(57) ABSTRACT

An improved device for exposing an emulsion-coated screen to light comprises an array of ultraviolet light-emitting diodes (UV-LEDs); a positive impression of the artwork to be printed; a relatively-flat transparent plate disposed between the array of UV-LEDs and the positive impression; a screen coated with a light-curable emulsion; the positive impression disposed on the side of the screen having the emulsion coat; a holding means, disposed on the side of the screen opposite the positive impression, for holding the screen in a planar position; and a means for electrically driving the UV-LEDs to emit ultraviolet light for a predetermined time period. The device can be formed into a compact device having a lid comprising the UV-LED array and a flat transparent plate of transparent material (such as glass), and driving and timing means for electrically driving the array of UV-LEDs to emit ultraviolet light for a predetermined period of time.

### CROSS REFERENCE TO RELATED APPLICATIONS

The present application claims the benefit of 35 U.S.C. §111(b) U.S. Provisional Application Ser. No. 61/855,934, filed May 28, 2013, entitled “Improved Screen Printing Device and Method”.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

This invention relates to the art of screen-printed shirts and, more particularly, to an improved device and method for exposing an emulsion-coated screen to light to produce a screen with an image and/or words through which ink can be passed onto a shirt or any other suitable object.

2. Description of Related Art

Screen-printing shirts with ink is well-known. Textiles and clothing, including shirts, particularly T-shirts, commonly carry artwork comprising designs, letters, and/or words. Prior art devices and methods utilize a positive impression of the artwork that is to be printed on the shirts to expose an emulsion-coated screen with light (typically light in the visual spectrum). The positive impression can be a clear film that has dark designs, letters, and/or words on the film. Other materials besides film can be used, but they all pass light except at the places where the designs, letters, and/or words appear.

In this application, a screen is frame holding a mesh of wires, or the like, such that a relatively flat stratum of curable emulsion can be disposed on the mesh, and wherein the wires are spaced such that ink can be pushed through the mesh to print a T-shirt or other article.

Light cures and hardens the emulsion that has been disposed on the screen. Before exposure to light, the emulsion coated on the screen is uniformly soft and unexposed. After being exposed to light, the emulsion coated on the screen is hardened on the screen anywhere that the light has fallen on the emulsion. Only those parts shaded from the light by the positive or dark part of the artwork are unexposed. After exposing the emulsion, the screen is washed with water to remove the soft unexposed parts of the emulsion-coated screen. Normally, only the positive image of the artwork on the emulsion will be unexposed and removed by washing with water. This, then, leaves a hardened emulsion on the screen with some parts (in the shape of the artwork) of the emulsion removed to leave only bare screen. The screen can then be placed adjacent a shirt and ink caused to move through the bare part of the screen and onto the shirt, to print the desired artwork on the shirt. Ink will not move through any part of the screen where hardened emulsion remains because the emulsion blocks the ink from moving through the screen.

The prior devices and methods of printing shirts are rather large, heavy, and bulky. Prior art devices normally dispose a single light source a certain distance from the emulsion-coated screen during exposure of the screen. This causes a registration between the positive impression of the artwork and the emulsion on the screen that is not sufficiently accurate due to parallax. It would be desirable to dispose the light source closer to the screen to minimize parallax in registration of the image of the artwork on the emulsion.

Further, the use of light sources that emit in the visual spectrum requires exposure for extended periods of time to adequately cure the emulsion. Exposure times of 1.5 minutes up to 15 minutes are considered normal in the prior art. It would be desirable to minimize exposure times to enable faster production of the printed shirts.

Prior art devices using a single metal halide bulb as a light source are large and cure the emulsion on the screens inconsistently because of parallax. Metal halide bulbs can cure the emulsion on the screen in 1.5 to 3 minutes.

Prior art devices using plural fluorescent bulbs can be made relatively small but take up to 15 minutes to cure the emulsion on the screen. The long curing time also yields an inconsistent curing of the emulsion.

Prior art devices using single or plural halogen bulbs are generally of medium size and take from 5 to 7 minutes to cure the emulsion on the screen.

All prior art emulsion curing light sources (fluorescent, halogen, and metal halide bulbs) take a relatively long time to heat up to an operating temperature. This produces a varying curing rate from one exposure to another, which produces inconsistent results. The faster bulbs consume more electricity in operation and seem to burn out more quickly.

All prior art emulsion curing light sources do not start at full brightness and they each increase to full power at varying intervals depending on usage, ambient temperature, and the power source. When one of the prior art curing source bulbs burns out, the unit cannot function until a new bulb is obtained and inserted into the unit.

When utilized in an emulsion-coated screen exposure unit, as is normally done in the prior art, prior art light sources are normally disposed in the bottom of the exposure unit. This necessitates the use of a vacuum top to hold the positive film to the emulsion coating, or the use of a heavy weight on a foam pad to ensure that the positive film is snugged up against the emulsion coat. A vacuum top adds weight, complexity, expense, and time during operation. Using a heavy weight and a foam pad is clumsy, and takes time. Both systems produce somewhat inconsistent results.

It would be desirable to utilize a curing source that was relatively small, inexpensive, and long-lasting, and which warms up quickly and provides a uniform exposure both on a particular emulsion and on successive curings.

### BRIEF SUMMARY OF THE INVENTION

An improved device for exposing an emulsion-coated screen to light comprises an array of ultraviolet light-emitting diodes (UV-LEDs); a positive impression of the artwork to be printed; a relatively-flat transparent plate disposed between the array of UV-LEDs and the positive impression; a screen coated with a light-curable emulsion; the positive impression disposed on the side of the screen having the emulsion coat; a holding means, disposed on the side of the screen opposite the positive impression, for holding the screen in a planar position; and a means for electrically driving the UV-LEDs to emit ultraviolet light for a predetermined time period. The device can be formed into a compact device having a lid comprising the UV-LED array and a flat transparent plate of transparent material (such as glass), and a driving and timing means for electrically driving the array of UV-LEDs to emit ultraviolet light for a predetermined period of time. The screen can be rectangular, and is held in a planar position by a frame disposed about the circumference of the screen. The screen is coated with a light-curable emulsion, and the screen is placed in an exposure position wherein a support means for supporting the screen in a planar position can be placed under the screen to support it against gravity. The support means can be a dark-colored rectangular block of rubber foam, or the like. A positive impression of artwork (a design and/or words and/or other art) is placed between the emulsion-coated screen and the plate of transparent material. The UV-LEDs are then electrically driven to emit ultraviolet light for a predetermined period of time to expose the emulsion coated on the screen. The exposed emulsion-coated screen is then removed from the compact device and the emulsion coating is washed (typically with water) to remove any unexposed emulsion. The unexposed part(s) of the emulsion will have been disposed directly under the positive part of the positive impression and, thus, not exposed to ultraviolet light when the UV-LEDs were driven to emit.

An improved method for exposing an emulsion-coated screen comprises the steps of: (1) coating a screen with a light-curable emulsion; (2) placing a positive impression of the artwork to be printed onto the emulsion-coated screen; (3) placing an array of UV-LEDs in close proximity to the positive impression and driving the UV-LEDs to emit ultraviolet light for a predetermined time. The light-exposed emulsion-coated screen can then be washed to remove any unexposed emulsion. The washed screen, which now has a negative image of the positive impression, can be used to push ink onto an object, such as a shirt or other clothing, or any other suitable item, as is known in the prior art.

The use of the device and methods described above enables the light source to be brought very close to the emulsion during exposure, minimizing registration errors due to parallax, and it significantly reduces the overall size and weight of the exposure unit. It also enables the use of an array of plural UV-LEDs to expose the emulsion instead of a single light source emitting in the visible spectrum. This use of ultraviolet light sources instead of a visible light source minimizes exposure time of the emulsion, which makes the production of inked shirts more rapid and economical. Using arrays of ultraviolet lights to expose the emulsion typically takes three or four seconds, but exposure has been accomplished anywhere from one to six seconds. This short exposure time provides a more consistent exposing environment than slower systems.

An advantage of utilizing UV-LEDs as a curing source for emulsion-coated screens is that the UV-LEDs have such a fast exposure time (usually three or four seconds) that they are not energized long enough to significantly alter the temperature of the LEDs or the unit as a whole. UV-LEDs operate at full power almost instantly upon being powered, and they draw relatively little power per exposure. UV-LEDs have a very long operative lifetime, and it is likely that they will not fail during the normal lifetime of a particular device using them. Another advantage of using an array of UV-LEDs is that they are small and light enough to dispose them in a top unit that can be placed on top of the positive film and the emulsion-coated screen, thereby eliminating the need for a vacuum unit or a weight to hold the positive film snugly against the emulsion coating. This simplifies the overall curing unit, reduces its cost, speeds its operation, and makes it much more portable.

The exposed emulsion-coated screen can be used to print words and/or designs on any suitable object such as textiles, particularly clothing.

### BRIEF DESCRIPTION OF THE SEVERAL VIEWS OF THE DRAWINGS

FIG. 1 shows one of the prior art devices that is used to screen-print shirts.

FIG. 2 shows a device comprising a preferred embodiment of the invention.

FIG. 3 shows a first step in the preferred method of the invention.

FIG. 4 shows a second step in the preferred method of the invention.

FIG. 5 shows a third step in the preferred method of the invention.

FIG. 6 shows a fourth step in the preferred method of the invention.

FIG. 7 shows a fifth step in the preferred method of the invention.

FIG. 8 shows a chart that compares the invention with prior art devices.

### DETAILED DESCRIPTION OF THE INVENTION

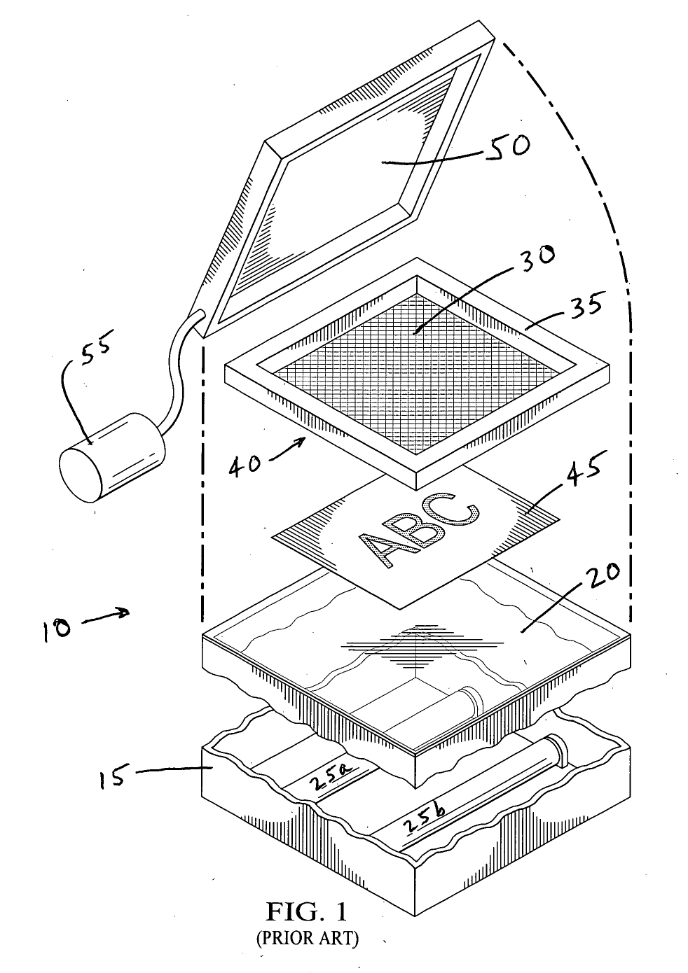

FIG. 1 shows one example of a prior art device that can be used to screen-print artwork onto a T-shirt or other article. The prior art device shown will create an exposed screen for pushing ink onto a shirt. The device shown in FIG. 1 is rather large and normally is not conveniently portable. A device 10 comprises a generally rectangular box 15 which has a transparent glass plate 20 on the top of the box 15, and plural fluorescent lamps 25a and 25b disposed near the bottom of the interior of the box 15. When illuminated by an electrical driving circuit (not shown), the light from the fluorescent lamps 25a and 25b can travel up and through the glass plate 20. Although FIG. 1 shows only two lamps, other examples of the prior art may comprise more than two lamps.

A screen 30, stretched and held in a relatively flat position by a frame 35, is coated with a light-curable emulsion 40. The emulsion 40 is normally coated on the side of the screen 30 facing away from the frame 35. A positive image of the intended artwork (here the letters “ABC”), which may include designs and/or letters and/or words, is printed in black on transparent or translucent film or paper. This positive image of the intended artwork will be referred to as the “positive film” here, even though something other than film (i.e., paper or plastic) can be used in its place. The positive film 45 is placed on the top of the glass plate 20 with the artwork right-side up. The screen 30 with the emulsion 40 is placed on top of the positive film 45 with the emulsion 40 adjacent the positive film 45 and the frame 35 generally upwards as shown in FIG. 1.

The emulsion 40 can be any suitable emulsion. One suitable emulsion is a photopolymer direct emulsion for use with plastisol inks. This emulsion is called “ChromaBlue” and is made by Chromaline, an IKONICS company.

A lid 50 is then placed on top of the frame 35 of the screen 30. It was usually necessary to have a vacuum system 55 connected to the lid 50 to create a vacuum within the lid, such that the positive film 45 is sucked up against the emulsion 40 on the screen. The operator then causes the electrical driving circuit to provide power to the fluorescent lamps 25a and 25b and cause them to simultaneously emit visible light for a predetermined amount of time. The visible light emitted by the lamps passes through the glass plate 20 and through the clear parts of the positive film 45 and onto the emulsion 40. Wherever the positive film 45 is black, the light does not pass through the black part and does not reach the part of the emulsion 40 adjacent to the black part of the positive film 45. Any part of the emulsion 40 which is struck by light from the lamps is cured and becomes relatively hard. Any part of the emulsion 40 which is not struck by light from the lamps is not cured and remains relatively soft; these non-cured portions can be easily washed off of the screen 30 with water. The cured parts of the emulsion 40 will not easily wash off with water.

After illuminating the emulsion 40 for the proper time, the operator lifts the lid 50 and removes the screen 30 and frame 40. The operator washes the screen 30 with water which removes any emulsion that was not cured, which will correspond to the black parts of the positive film 45.

Therefore, after curing with light, the emulsion 40 contains a negative image of the positive film 45. In other words, where the positive film was dark, there is an opening in the emulsion through the screen. Where the positive film was clear (or relatively so), the emulsion is hard and remains on the screen.

The operator can then place the screen 30 over a T-shirt, or other article, and push ink through the openings in the emulsion 40 on the screen 30. The ink will be absorbed by the T-shirt or other article, and will create a positive image of the intended artwork.

It is important for the dark image on the positive film 45 to register well with the emulsion 40 on the screen 30. If there is anything but exact registration between the dark image on the positive film 45 and the emulsion 40, the subsequent ink image that is placed onto the T-shirt or other article will not exactly match the desired artwork. This is undesirable, especially when aligning multiple colors using multiple screens. One source of error in registration between the dark image on the positive film 45 and the emulsion 40 may arise from parallax due to the different light rays emitted from individual lamps. The light rays from lamp 25a will strike the positive film 45 at a slightly different angle than the light rays from lamp 25b, due to their slightly different positions. This is why the plural lamps 25 must be disposed a substantial distance from the positive film 45, in some cases two or three feet in distance. If plural lamps were disposed near the positive film 45, the resulting parallax errors would produce an undesirable result.

Further, because curing is achieved with visible light, the exposure time for the emulsion is rather long (i.e., on the order of three or four seconds to over one minute). This slows the process of producing screen-printed T-shirts.

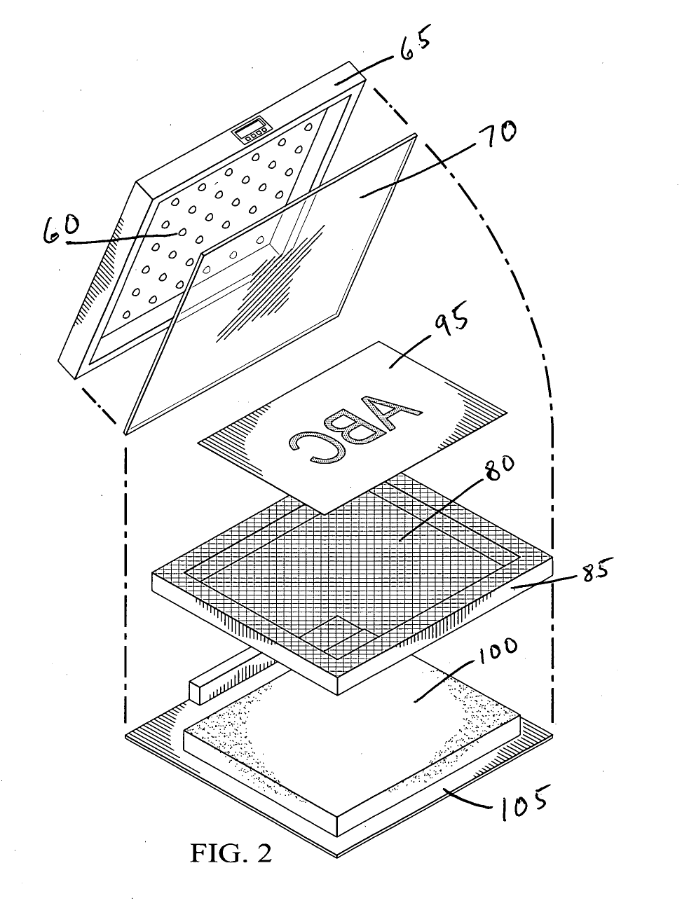

FIG. 2 illustrates the concept of my invention. In a preferred embodiment of my invention, an array 60 of ultraviolet light emitting diodes (UV-LEDs) is disposed in a lid 65. In the illustration of FIG. 2, an array of 6 by 6 (or 36) UV-LEDs is shown, but the number of LEDs and their arrangement is a matter of design choice, as long as a substantial number of UV-LEDS is chosen and as long as they are distributed relatively evenly around the field to be exposed with ultraviolet light.

A transparent glass plate 70 is disposed below the array 60 of UV-LEDs to prevent objects from coming into contact with the individual LEDs and to provide a flat surface against which a film positive 75 can rest. In the preferred embodiment, the glass plate 70 and the array of UV-LEDs are connected together as one unit, but this need not necessarily be so. Further, the transparent glass plate 70 could be anything that is relatively flat, sturdy, and transparent. For example, a sheet of firm transparent plastic could be used in place of the transparent glass plate 70. It might even be possible to eliminate the glass plate entirely if the film positive can be firmly disposed on the emulsion in a flat manner during the time the UV-LEDs are illuminated. Persons of ordinary skill in this art will be able to conceive of alternative embodiments that come within the scope of my invention.

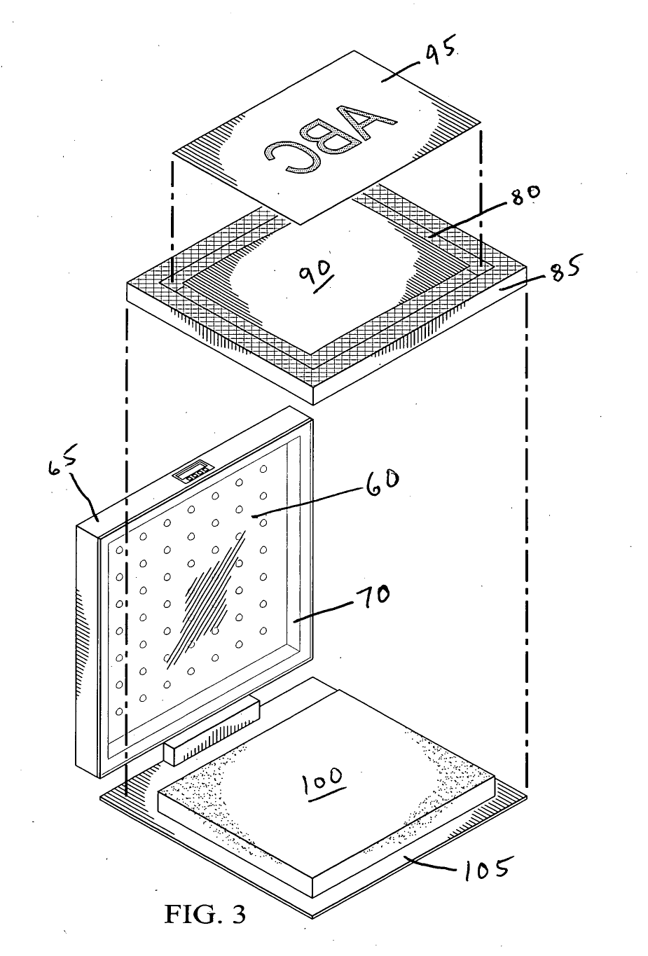

A screen 80 supported by a frame 85 as described above has a light-curable emulsion 90 (shown in FIG. 3) disposed on the screen with the emulsion 90 situated on the top of the screen away from the frame 85. Emulsion can be applied to either side of the screen or to both sides. The screen 80, frame 85 and emulsion 90 are the same as described above for FIG. 1, except that the combination is oriented oppositely, with the emulsion 90 on the screen 80 facing up and the frame 85 down, as shown in FIG. 2.

A positive film 95, which is the same as the positive film 45 as described above, is placed face-downwards on the emulsion which has been coated onto screen 80. The emulsion is not shown in FIG. 2, but can be seen in FIG. 3. One will notice that the orientation between the film positive 95 and the emulsion 80 of my invention is the same as the orientation between the film positive 45 and the emulsion 40 of the prior art device shown in FIG. 1. I have inverted the prior art process to take full advantage of the fact that my light source is relatively small and my overall exposure unit is relatively light, so that the light source 60 can be placed above the screen 80, although it work as well disposed below the screen 80.

A block 100 of foam rubber or the like is placed upon a flat substrate 105. The block 100 of foam rubber is designed to have dimensions such that, when the frame 85 is placed around the block 100, the thickness of the block 100 will hold the screen 80 in a planar manner. In other words, the block 100 of foam rubber has the purpose of supporting and holding the screen 80 so that the screen 80 does not sag when the positive film is illuminated by the UV-LEDs. The foam block 100 is designed to purposely sag. If the screen frame is warped or not flat, the glass will still completely press against the mesh of the screen. This compression of the foam block 100 provides pressure to hold the positive film tightly in place, eliminating the need for a vacuum lid and air pump. My improved device has a lower tray with the foam block 100 attached. This tray can be removed and replaced with a tray that has larger or smaller foam blocks for exposing various sizes of screens. The tray can also have multiple foam blocks attached, allowing the operator to expose multiple screens at the same time. A larger unit can be made to accommodate more screens, or a unit can be made smaller to be more compact and light while not accommodating as many screens. The light source can be disposed above or below the screen as desired. This will all be a matter of design choice, depending on the particular needs of the user.

FIGS. 3 to 7 help to illustrate the process of utilizing my invention. It will be apparent that a device comprising my invention will be much more compact than prior art devices. In fact, it will be so compact as to be easily portable. This easy portability can be a substantial benefit to operators who make T-shirts. Further, the use of UV-LEDs as a curing means enables exposure times of six second or less, thereby reducing the time needed to cure the emulsion. I currently get good results with an exposure time of four seconds, but exposure time will naturally depend on the intensity of the output of the UV-LED array used. Because the array of UV-LEDs is able to be placed very near the emulsion, and because there are relatively more UV-LEDs than fluorescent lamps, my invention produces better registration between the positive film and the emulsion.

My preferred embodiment can eliminate the vacuum system that was usually required in the prior art devices. In my preferred embodiment, the film positive 95 rests upon the emulsion 80. Gravity will keep the film positive 95 snugly adjacent the emulsion without the need for any vacuum system. It is the ability to orient the film positive and the emulsion in this manner that provides the benefit of eliminating the vacuum system which makes my preferred embodiment even more compact and portable and minimizes its cost. This is an unexpected benefit of utilizing UV-LEDs instead of fluorescent lamps to cure the emulsion.

In FIG. 3, the lid comprising the array 80 of UV-LEDs (which here is shown with an array of 7 by 7 LEDs) and the transparent glass plate 70 has been moved up and away from the block 100 of foam rubber which is disposed upon a flat substrate 105. The screen 80 is coated on one side with a light-curable emulsion. The combination of the screen 80, the emulsion 90, and the frame 85 is then placed upon the block 100 of foam rubber such that the block 100 fits within the frame 85 and supports the screen 80 to lie in a flat planar position. The positive film 95 can then be placed upon the emulsion 90. As is apparent in the drawing, the positive film 95 is placed upside-down upon the emulsion 90. The lid 65 with the array 60 of UV-LEDs and the transparent glass plate 70 can be placed on top of the positive film 95 by the operator, snugly compressing the glass to the screen, with the positive film pressed immobile between them because of the weight of the lid and the slight give of the foam block. The operator can now cause the UV-LEDs to be electrically driven for a predetermined time. This will usually be done with an electrical control circuit (not shown) which has a variable timing circuit with a particular driving time either hard-wired into the control circuit or which has a control for the operator to manually designate one of several particular time periods for driving the UV-LEDs. These control circuits are either known or well within the level of ordinary skill in this art.

The UV-LEDs preferably all simultaneously emit ultraviolet light for the predetermined time period. However, the driving circuit could be arranged to drive individual UV-LEDs one at a time or in groups sequentially. It is possible in certain applications that certain LEDs or groups of LEDs might be driven for different time periods or at different intensities. The UV-LEDs in the array 80 are preferably all identical, but it may be desirable for certain applications to use different UV-LEDs, or even different types of light sources (i.e., visible light emitting LEDs, visible light emitting bulbs, etc.); in the array 80. The actual number of UV-LEDs in the array 80 and the exact arrangement of the UV-LEDs in the array 80 is a matter of design choice. However, it is preferable that the UV-LEDs in the array 80 be spaced relatively uniformly: It is also preferable that each UV-LED in the array 80 be spaced uniformly with respect to the glass plate 70. The UV-LEDs should be relatively close to the glass plate 70, but the exact spacing between the UV-LEDs and the glass plate 70 is a matter of design choice.

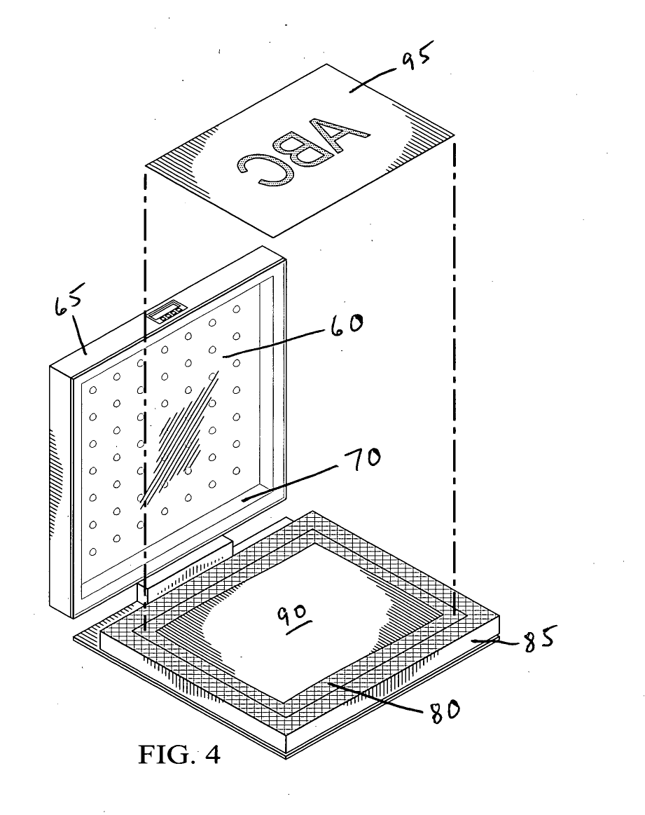

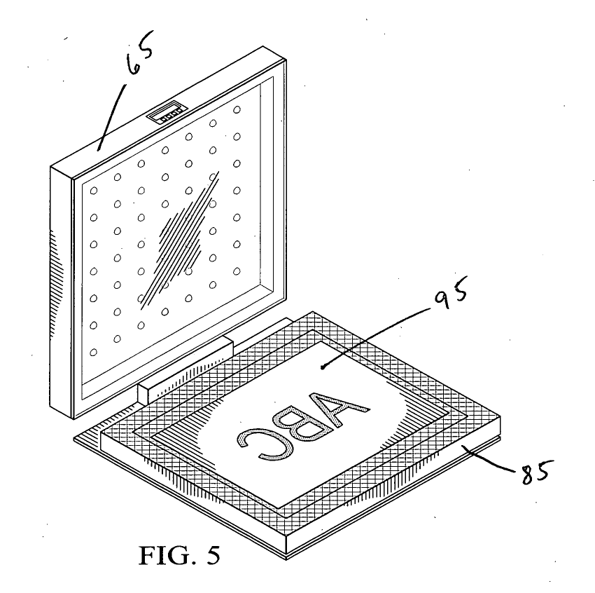

FIG. 4 shows the screen 80 laid upon the block 100 of foam rubber which holds the emulsion 90 on the screen flat. Then the positive film 95 is oriented in the proper manner, as shown in the drawing, and laid upon the emulsion 90. This is shown in FIG. 5. In FIG. 6, the lid 65 has been closed or placed upon the positive film 95. The glass plate 70 will lie on and press against the positive film 95.

The operator then causes the array 60 of UV-LEDs to be energized for the proper time period. Wherever the positive film 95 is clear or translucent, the ultraviolet light will pass through the positive film 95 and cure the portion of emulsion 90 directly below it, making it relatively hard or cured. Wherever the positive film 95 is dark or black, the ultraviolet light from the UV-LEDs will be absorbed by the dark or black portion of the positive film 95 and the portion of the emulsion 90 directly below it will not be cured and will remain relatively soft.

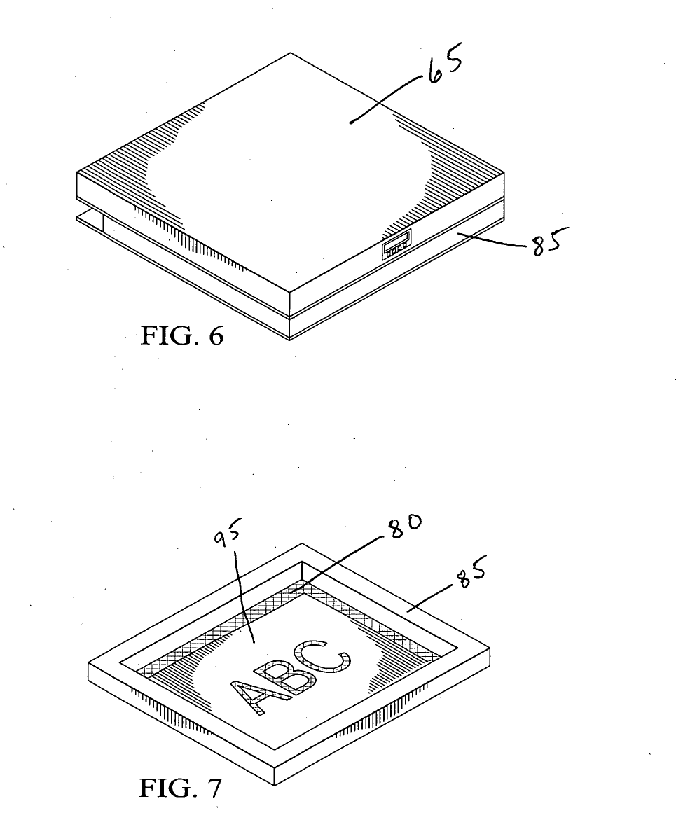

FIG. 7 shows the emulsion 90 on the screen 80 after exposure to the ultraviolet light. The lid 65 has been lifted or removed and the positive film 95 has been removed. The screen 80 has been lifted up and turned over. The emulsion 90 shown in FIG. 7 shows the letters “ABC” in the middle as still relatively soft and uncured, while the rest of the emulsion 90 surrounding the letters are cured and relatively hard. The operator can now wash the screen 80 and emulsion 90 with water to wash off the soft uncured portion corresponding to the letters “ABC”. In other words, the emulsion 90 is open in the form of letters “ABC” but closed around these letters. Then the operator can use the prepared screen 80 to mark a T-shirt or other object by pushing ink of any color through the emulsion as is known in this art. This will produce an ink image in the form of letters “ABC” on the T-shirt or other object. Thus, the process described above has been used to produce the image desired on the T-shirt or other object. Naturally, any image can be produced on the T-shirt or other object in this manner. The image may comprise one or more of art, designs, letters, numbers, or any image that might be desired. To produce images on T-shirts using multiple colors, the operator can follow this method one color at a time to produce a multi-colored image on the T-shirt or other object.

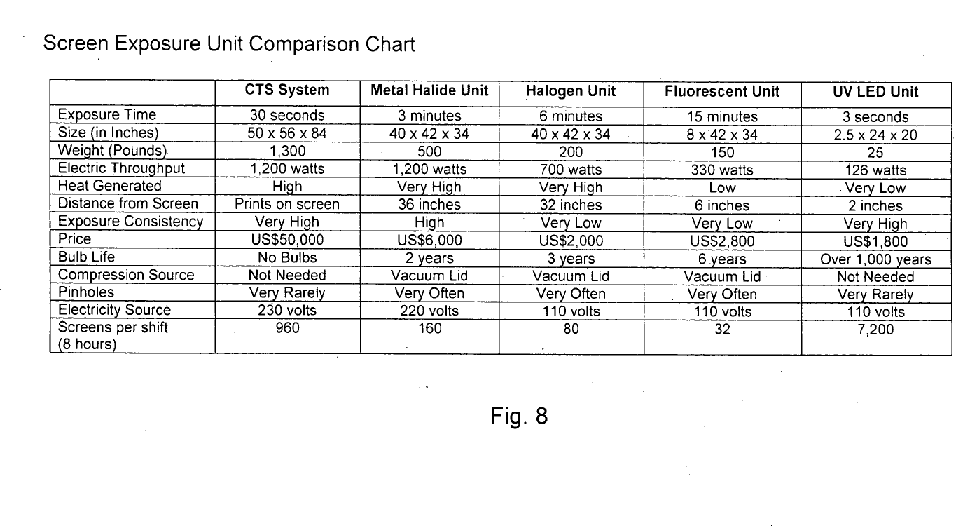

The chart shown in FIG. 8 shows a comparison of the use of ultraviolet LEDs with other screen exposure units in screen-printing. The chart compares various factors of CTS (computer-to-screen imaging) systems, metal halide lamps, halogen lamps, and fluorescent lamps with UV LEDs. It is apparent from the information presented in the chart that UV LEDs maximize production and quality, and minimize cost, heat, weight, size, and problems compared to the other screen exposure units. This clearly demonstrates the desirability of the present invention.

Although my preferred embodiment comprises an array of plural ultraviolet light-emitting sources, it is possible to practice my invention with only one ultraviolet light-emitting source. For example, one could replace the array of UV-LEDs in the preferred embodiment described above with one ultraviolet light source, such as a UV-LED. The device and method I have previously described would work the same with a single UV light source. As is apparent to the person of ordinary skill in this art, registration errors due to parallax caused by the single light source being close to the emulsion during exposure may be greater than when an array of plural UV-LEDs is used. But, in some situations, this may be acceptable.

Further, it is also possible to practice my invention with at least one UV light source and moved across the emulsion to expose the entire emulsion. This alternative would provide either a single UV light source or a small array of plural UV light sources, which are then moved around or across the emulsion at a speed that is suitable for properly exposing all areas of the emulsion equally. In one alternative, a single UV light source could be disposed close to the emulsion and the positive impression of the artwork to be printed. The single UV light source would be mechanically moved across or around the emulsion and positive impression while the light source is illuminated to adequately cure the exposed part of the emulsion. Persons of ordinary skill in this art will be able to coordinate the output of the UV light source and the speed at which it is moved across or around the emulsion to provide the desired curing of the emulsion. In another alternative, plural UV light sources would be arranged close to the emulsion and positive impression, and the plural UV light sources would be moved across or around the emulsion and positive impression while the light sources are illuminated to adequately cure the exposed emulsion. In this alternative, the plural UV light sources could move independently of one another or in a coordinated fashion. The plural light sources may be disposed individually at different locations near the emulsion, or they may be grouped together in a united array wherein the array is moved across or around the emulsion. There could be multiple arrays of UV light sources wherein each array has one or more UV light sources disposed in that particular array, and each array is moved across or around the emulsion either simultaneously or sequentially. Again, a person of ordinary skill in this art would be able to coordinate the output of the light source(s) and the speed of movement of each light source or array of light sources, such that the desired curing is achieved after the UV light sources have been illuminated and moved.

The preceding description of the preferred embodiment and preferred method are only examples of this invention. After reading this disclosure, persons of ordinary skill in this art will be able to conceive other examples, embodiments, and methods that come within the scope of this invention. This invention is not limited to the preferred embodiment and method stated above. It is meant to be limited only by the following claims.

I claim:

1. A device for exposing an emulsion stratum to light comprising plural sources of ultraviolet light closely adjacent the emulsion stratum.

2. A device for exposing an emulsion-coated screen to light comprising plural ultraviolet light-emitting diodes closely adjacent the emulsion-coated screen.

3. Plural ultraviolet light-emitting diodes disposed in an array such that each diode's emission is aimed in the same direction and each diode's emission is aimed orthogonally with respect to the plane of the array; a flat stratum of emulsion that is disposed near and parallel to the array of diodes; and an image that is opaque to ultraviolet radiation disposed between the array of diodes and the flat stratum of emulsion.

4. Curing a layer of curable emulsion coated on a relatively flat screen by disposing over the emulsion layer a positive image of a design on a sheet, with the image comprising various transparent and opaque areas, and causing plural light sources to emit electromagnetic radiation in the direction of the emulsion, which radiation passes through only the transparent areas of the sheet, whereby only areas of the emulsion directly adjacent the transparent areas of the sheet are cured, and those areas of the sheet which are directly adjacent the opaque areas of the sheet remain uncured.

5. A device for curing an emulsion, comprising:
1) plural ultraviolet light sources, all arranged to direct the light produced in one direction;
2) a stratum of light-curable emulsion;
3) a positive image in or on a sheet comprising various areas of the sheet that are transparent and opaque, said transparent and opaque areas arranged in a design that comprises at least one of letters, numbers, symbols, art, a design, and a composition;
4) wherein the positive image is placed between the stratum of light-curable emulsion and the plural ultraviolet light sources, and the plural ultraviolet light sources are driven to emit ultraviolet light for a predetermined period of time, whereby the ultraviolet light passes through the transparent portions of the positive image and cures that part of the emulsion it strikes, and whereby the ultraviolet light that strikes the opaque portions of the positive image is absorbed by the positive image, leaving the part of the emulsion not, illuminated by the ultraviolet light uncured.

6. The device of claim 5 further comprising a flat sheet of hard transparent material interposed between the plural ultraviolet light sources and the positive image.

7. The device of claim 6 wherein the sheet of transparent material is one of glass and plastic.

8. An improved device for exposing an emulsion-coated screen to light comprises:
1) an array of ultraviolet light-emitting diodes (UV-LEDs);
2) a positive, impression of the artwork to be printed;
3) a relatively-flat transparent plate disposed between the array of UV-LEDs and the positive impression;
4) a screen coated with a light-curable emulsion;
5) the positive impression disposed on the side of the screen having the emulsion coat; a holding means, disposed on the side of the screen opposite the positive impression, for holding the screen in a planar position; and
6) a means for electrically driving the UV-LEDs to emit ultraviolet light for a predetermined time period.

9. A method comprising the steps of:
1) forming an emulsion into a stratum; and
2) curing at least a part of the emulsion stratum with ultraviolet light.

10. A method comprising the steps of;
1) disposing an emulsion onto a relatively flat screen;
2) disposing an array of ultraviolet light-emitting diodes such that the array of diodes is parallel to and adjacent the emulsion on the screen;
3) disposing an opaque image between the emulsion and the array of diodes; and
4) causing the array of diodes to emit ultraviolet light for a predetermined time.

11. The method of claim 10 wherein during the step of causing the array of light-emitting diodes to emit ultraviolet light for a predetermined time, all light-emitting diodes emit ultraviolet light simultaneously.

12. The method of claim 10 wherein during the step of causing the array of diodes to emit ultraviolet light for a predetermined time, all diodes emit ultraviolet light sequentially, such that at least one diode of the array emits ultraviolet light during a time period after at least one other diode of the array has emitted ultraviolet light.

13. A device for exposing an emulsion stratum to light comprising a light source which cures exposed emulsion in less than ten seconds.

14. A device for exposing an emulsion stratum to light comprising an emulsion-coated screen having a positive film disposed on top of it, and having a light source disposed over the positive film.

15. A device for exposing an emulsion stratum to light comprising:
1) an emulsion-coated screen;
2) a positive film disposed adjacent to the emulsion-coated screen;
3) a transparent plate; and
4) an array of individual light sources; wherein the array of individual light sources is disposed apart from, but very near to the emulsion-coated screen.

16. The device of claim 15 wherein the number of individual light sources exceeds 10.

17. The device of claim 15 wherein the number of individual light sources exceeds 20.

18. The device of claim 15 wherein the distance between the array of individual light sources and the plane of the emulsion-coated screen is substantially less than the length or width of the emulsion coating on the screen.

19. The device of claim 15 wherein the distance between the array of individual light sources and the plane of the emulsion-coated screen is ten inches or less.

20. The use of plural ultraviolet light emitting diodes in the curing of a photopolymer emulsion.
